(19) United States
(12) Patent Application Publication
(10) Pub. No.: US 2026/0285297 A1
(43) Pub. Date: Sep. 24, 2026

(54) GAZE BEHAVIOUR-BASED PARKING ASSIST SYSTEM CONTROL OF A VEHICLE

(71) Applicant: MERCEDES-BENZ GROUP AG, Stuttgart (DE)

(72) Inventor: Christian SCHNEIDER, Radolfzell am Bodensee (DE)

(21) Appl. No.: 19/474,355

(22) PCT Filed: Mar. 7, 2024
(86) PCT No.: PCT/EP2024/055993

§ 371 Date: Oct. 10, 2025

(30) Foreign Application Priority Data
Apr. 11, 2023 (DE) 10 2023 001 414.1

(51) Int. Cl. B60W 30/06; B60W 40/08; B60W 50/00; B60W 50/10; G06V 20/59; G06V 40/18

(52) U.S. Cl. CPC B60W 30/06; B60W 40/08; B60W 50/10; G06V 20/597; G06V 40/18; B60W 2050/0083; B60W 2420/403; B60W 2540/225; B60W 2552/00; B60W 2556/40; B60W 2556/50

(57) ABSTRACT

An automatic parking assist of a vehicle is controlled using a computing unit and a driver observation camera that detects gaze behavior of the driver. The computing unit infers from certain patterns of fixations and saccades in the gaze behavior of the driver an intention to park the vehicle in a parking space and, if such an intention is detected, to activate the automatic parking assist. The computing unit determines a flat road course, assigns the driver's gaze directions to the current surroundings of the vehicle, and excludes fixations with a gaze direction towards the flat road course and/or saccades with gaze directions over at least part of the flat road course from a check of the patterns in the gaze behavior for an intention to park.

### BACKGROUND AND SUMMARY OF THE INVENTION

Exemplary embodiments of the invention relate to a system for controlling an automatic parking assist of a vehicle, and a vehicle having such a system.

The following information does not necessarily emerge from a specific document from the prior art, but rather from practical considerations and practical experience: modern vehicles often have a parking assist system that is typically not only capable of virtually marking spaces for a driver of the vehicle, but also, particularly in modern passenger cars, of autonomously parking the vehicle in a selected parking space. In order for the driver of the vehicle to know exactly where the parking space for automated parking is located, it must typically be marked accordingly; in this case, it is advisable to offer the driver a plurality of possible parking spaces to choose from. First, however, it must be determined whether the driver of the vehicle actually wants to park the vehicle. If, for example, a plurality of possible parking spaces are offered to the driver, particularly visually, below a certain speed threshold, this can lead to unwanted behavior of the vehicle and parking spaces may be marked and offered even if the driver has no intention of parking, for example when the vehicle is travelling in slow-moving city traffic at a constantly changing but slow speed. This would irritate the driver. In the prior art, it is known to automatically analyze the driver's gaze behavior and to use parking systems accordingly after evaluating the gaze behavior.

DE 10 2012 221 036 A1 relates to a method for automatically activating a parking and/or maneuvering assist system in a motor vehicle, having the steps: determining the driver's gaze behavior; evaluating the gaze behavior; and automatically activating the parking and/or maneuvering assist system depending on the evaluation of the gaze behavior. In particular, in DE 10 2012 221 036 A1, the driver's gaze behavior is used to determine fixations with a minimum fixation duration and saccades.

Exemplary embodiments of the invention are directed to improving the use of a parking assist system depending on a detected gaze behavior of a driver of a vehicle.

A first aspect of the invention relates to a system for controlling automatic parking assist of a vehicle, having a computing unit and a driver observation camera connected to the computing unit, wherein the driver observation camera serves to detect the gaze behavior of the driver of the vehicle and the computing unit is designed to infer from certain patterns of fixations and saccades in the driver's gaze behavior an intention to park the vehicle in a parking space and, if such an intention is detected, to activate the automatic parking assist at least in part, characterized in that the computing unit is designed to determine the flat road course of a section of road lying in front of the vehicle in the direction of travel, to assign the driver's gaze directions to the current surroundings of the vehicle, and to exclude fixations with a gaze direction towards the flat road course and/or saccades with gaze directions over at least part of the flat road course from a check of the patterns in the gaze behavior for an intention to park.

Preferably, to recognize an intention to park based on corresponding patterns, only fixations in gaze behavior above a specified minimum fixation duration are evaluated. Shorter fixations are more indicative of scanning the surroundings in order to form a spatial image of the environment. This is typical human behavior when assessing the surroundings, as the point of sharpest vision is limited to a narrower angle range and therefore a plurality of eye movements are necessary to scan the surroundings in order to mentally piece together the numerous detailed sections of the surroundings that have been captured. In contrast, a fixation above the specified minimum fixation duration tends to indicate that a parking space that is viewed by the driver of the vehicle for longer than the minimum fixation duration is considered a potential parking space.

In contrast to fixations in the driver's gaze behavior, saccades are rapid eye movements that are typically performed by both eyes simultaneously and occur between two phases of fixation. Due to the speed of the eye movements, which exceed the range typical for humans in saccades, correspondingly less detailed information about the environment is perceived.

The driver's gaze behavior is recorded using the driver observation camera. This is used, in particular, to detect the driver's eye movements and gaze directions. The driver observation camera is advantageously positioned in the vehicle interior such that its detection range is directed at the driver's head area. With appropriate eye tracking modules (so-called ‘eye trackers’), it is then possible to continuously observe the driver's gaze behavior and analyze it with the computing unit. Advantageously, the captured gaze behavior is first analyzed by the computing unit to determine fixations and saccades and, in particular, to classify the driver's gaze into exclusively one of the categories of fixations and saccades in order to facilitate pattern recognition.

The computing unit is designed, in particular, to check the sequence of fixations and saccades for patterns in which saccades and fixations occur in rapid succession. However, further criteria can be specified in the requirements for patterns in gaze behavior, in particular certain geometric trajectories of the saccades and thus relative positions of the fixations in relation to one another.

However, in this pattern recognition, in accordance with the invention, the gaze behavior is not taken into account continuously and thus all fixations and saccades in the driver's gaze behavior evaluated; rather, gazes directed at the section of road in front of the vehicle are disregarded. If pattern recognition is carried out in such a way that the driver's gaze and eye movements captured by the driver observation camera are projected onto the area around the vehicle, this projection hides the area around the road section ahead and, preferably, other possible roads to be travelled on, and glances directed there are disregarded. In particular, the image from the driver observation camera is masked with an image of the road course projected onto it or with areas of the road course transformed into a coordinate system of the driver observation camera; in other words, the corresponding image of the road section is hidden from the image from the driver observation camera. This means that the road sections are known in the driver observation camera coordinate system and act as a filter or mask to mask out the saccades/fixations in this area. These road sections are each taken into account as a flat road course, i.e., an elongated extension along the lanes on the road course and the width of the road, which in combination describe the surface of the road. It is assumed that the driver's gaze on this surface of the road does not correspond to an intention to park there. This surface of the road is therefore appropriately linked to the fixations and saccades in the driver's gaze behavior by means of corresponding projections and/or coordinate system transformations in such a way that glances directed at the flat road course in the form of fixations or saccades that at least partially cover these, in particular only these, may not be interpreted as an intention to park and are therefore excluded from the analysis of the gaze behavior.

If such a pattern is detected which, according to the specified criteria, indicates the driver's intention to park, the computing unit activates the automatic parking assist. Activation of the parking assist means, preferably, that the driver of the vehicle is offered a plurality of possible parking spaces to choose from, such that, in particular after selection and (optionally automatic, an accompanying) confirmation of the desire for parking assist by an automated control system of the vehicle, the vehicle can be parked independently or at least with assist in the selected parking space. This is particularly advantageous in tight parking spaces.

One advantageous effect of the invention is that physical devices typically installed in modern vehicles, such as an interior camera for driver observation (functioning as a driver observation camera) and a computing unit with sufficient computing power for image analysis, can already be used without requiring additional devices. Only the software needs to be adapted in order to improve the system for controlling automatic parking assist. The human-machine interface can thus be improved depending on customer requirements. If the position of the vehicle is also determined by satellite and the course of the road section in the direction of travel in front of the vehicle is determined using a pre-stored digital map, no external sensors are required on the vehicle. Intention recognition for the driver of the vehicle when searching for a parking space is also improved and made considerably more reliable, as false positive recognitions of the driver's intention to park are better prevented. Such false detections could easily occur without the blanking out of the road ahead if the vehicle is in a traffic jam, for example on the motorway, where the lane markings applied to the road at wide intervals are tracked by the driver, especially on winding roads where road boundaries such as fences, plantings, emergency telephones, warning beacons or other features are tracked, or in so-called ‘stop and go’ traffic, especially in city traffic, where the driver must be highly attentive and thus, for example, observe the vehicle in front and lane markings at short intervals.

According to an advantageous embodiment, the computing unit is designed to determine the flat road course of the road section in the direction of travel in front of the vehicle by determining the current position of the vehicle and by assigning the determined position to a digital map with stored road courses.

The current position of the vehicle in each case is preferably determined by means of satellite-based positioning, but can be supported by additional sensors, such as inertial sensors (preferably a compass, among others), environment detection, and others. When determining the position, it is also preferable to determine the orientation of the vehicle in order to determine the actual alignment with the road section ahead not only on the basis of map data (which assumes an expected alignment on the road), but also to take into account the vehicle's angle of inclination, for example when avoiding potholes or other obstacles, as well as individual cornering and lane guidance.

According to a further advantageous embodiment, the computing unit is designed to determine the position angle of the vehicle relative to the flat road course of the road section based on the road course according to the digital map and/or by means of an inertial measuring unit.

According to a further advantageous embodiment, the system further comprises an environment observation camera connected to the computing unit for detecting an area in front of the vehicle, wherein the computing unit is designed to determine a vector field of an optical flow of the environment moving relative to the moving vehicle from current data from the environment observation camera, and to take into account a reference of the gaze behavior to the vector field of the optical flow when checking patterns in the gaze behavior for an intention to park.

According to this embodiment, it is taken into account that, in particular, a rapid sequence of successive fixations and saccades alternating along an optical flow of objects in the environment indicates the intention to park, as the driver's gaze then wanders from one potential parking space to the next, and because of the driver's own driving speed, the optical flow causes the sequence of fixations and saccades to occur at a certain minimum frequency on average, depending on the driving speed; in this respect, pattern recognition takes into account the driving speed and thus the optical flow of the environment relative to the driver's own vehicle and its effects on the driver's gaze behavior when searching for a parking space.

According to a further advantageous embodiment, the computing unit is designed to determine, by analyzing the saccades, values for at least one of the parameters “orientation”, “repeatability” and “connection”, wherein the parameter “orientation” indicates a respective orientation of the saccades relative to the direction vectors of the vector field of the optical flow, wherein the parameter “repeatability” characterizes a sequence of the saccades among themselves, and wherein the parameter “connection” indicates the length of the individual saccades, and wherein the computing unit is designed to infer an intention to park depending on the respective determined values of the at least one parameter.

The “orientation” parameter specifies the respective orientation of the saccades relative to the direction changes of the vector field of the optical flow. For comparison, the nearest orientations of the optical flow are used here. The “repeatability” parameter, on the other hand, characterizes a sequence of saccades among themselves. By way of example, the saccades follow a line or a zigzag pattern is recognizable. The “connection” parameter can be used to check whether saccades comprise a parking space length or, if necessary, occur due to road boundaries such as a fence/barrier. The parameters mentioned are therefore particularly suitable for characterizing the shape of saccades, especially in relation to the determined optical flow of the environment relative to the vehicle.

According to a further advantageous embodiment, the computing unit is designed to determine the respective value of the at least one parameter by means of a respective histogram, wherein the respective histogram indicates occurrence frequencies of the individual values of the parameters, in order to form parameter mean values as the final value of the respective parameter from the respective histogram.

By way of example, to suppress false positives along a horizontal ladder, etc., values are primarily sought that comprise the common width of parking spaces. These values are preferably derived repeatedly for each of a number n of frames from the driver observation camera. For all of a number m of frames, three histograms (for the three parameters) are preferably formed on their basis. In these histograms, an area relevant for detecting the driver's intention is defined, based in particular on previous application journeys. In this area, the frequency is averaged and evaluated.

According to a further advantageous embodiment, the computing unit is designed to determine a weighted sum of the final values of the parameters “orientation”, “repeatability” and “connection” and to compare the result of the sum with a predetermined limit value and, if the limit value is not reached, to conclude that there is an intention to park.

According to a further advantageous embodiment, the computing unit is designed to adjust weighting factors of the weighted sum and/or the limit value on the basis of learned field data.

The weighting factors of the weighted sum of the parameters can be determined by application runs or adjusted by customer behavior in the field. The limit value can also be adjusted adaptively during subsequent regular operation of the vehicle, in particular by recording a history of the parameters and determining a limit value during manual parking maneuvers based on this history.

According to a further advantageous embodiment, the computing unit is designed to perform the adjustment differently for individual drivers.

A further aspect of the invention relates to a vehicle having a system as described above and below.

Advantages and preferred developments of the proposed vehicle emerge from an analogous and appropriate transfer of the above explanations made in connection with the proposed system.

Further advantages, features and details emerge from the following description, in which—if necessary, with reference to the drawing—at least one exemplary embodiment is described in detail. Identical, similar and/or functionally identical parts are provided with identical reference numerals.

### BRIEF DESCRIPTION OF THE DRAWING FIGURES

It shows:

FIG. 1 a system for activating an automatic parking assist according to driver observation in a vehicle according to an exemplary embodiment of the invention and

FIG. 2 optical flow and exemplary saccades 2, 2′

The representations in the figures are schematic and not to scale.

### DETAILED DESCRIPTION

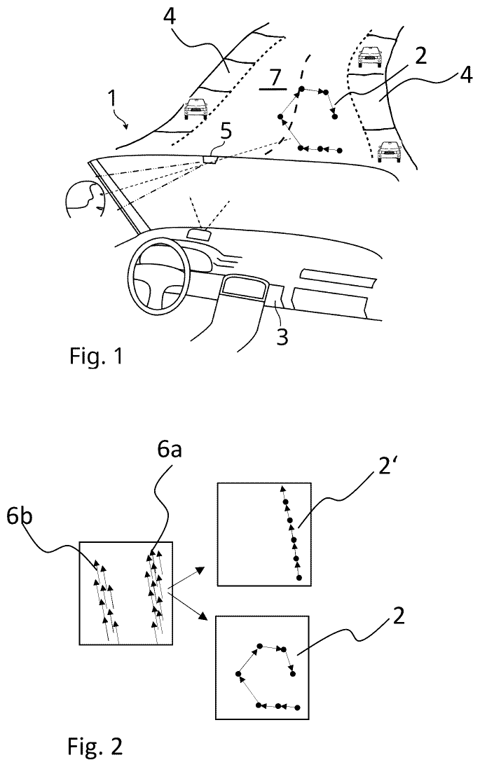

FIG. 1 shows a system for conditionally activating an offer to execute an automatic parking assist of a vehicle 1. The system has a computing unit 3 and a driver observation camera 5 connected to the computing unit 3 in the interior of the vehicle 1. This driver observation camera 5 is directed with its detection area towards a headrest and thus towards the head of the driver of vehicle 1 and serves to detect the gaze behavior of the driver of vehicle 1. Eye movements performed by the driver of vehicle 1, in particular so-called saccades 2, as well as fixations on objects in the vicinity of the vehicle, during which the driver looks at an object in the vicinity of the vehicle for a certain period of time, can thus be detected by the driver observation camera 5 and transferred to the computing unit 3 for analysis. The computing unit 3 is also designed to infer from certain sequence patterns of fixations and saccades 2,2′ in the driver's gaze behavior an intention to park the vehicle 1 in a potential parking space 4, see FIG. 1 and FIG. 2. For this purpose, an environment observation camera connected to the computing unit 3 is also used to capture an environment in front of the vehicle 1. The computing unit 3 of the vehicle 1 uses its data to determine a vector field of an optical flow 6a, 6b of the environment moving relative to the moving vehicle 1, as shown in FIG. 2. FIG. 2 shows the optical flux in the areas relevant for parking on the left-hand side of the road 6a and the right-hand side of the road 6b from FIG. 1, which is extracted by the computing unit.

Furthermore, a reference of the gaze behavior to the vector field of the optical flow 6a is taken into account when checking patterns in the gaze behavior as follows: by analyzing the saccades-see exemplary saccades 2, 2′ in FIG. 2—end values of the parameters “orientation”, “repeatability” and/or “connection” are determined. The “orientation” parameter indicates the respective orientation of the saccades relative to the direction vectors of the vector field of the optical flow. The orientation is preferably determined as the angle between the fixations represented as points and the saccades 2, 2′ represented by vector arrows.

The “repeatability” parameter characterizes a sequence of saccades in relation to each other, i.e. preferably represented by the angles of the vector arrows to each other, for example, the saccades follow a line or a zigzag pattern.

The “connection” parameter specifies the length of the individual saccades. In order to exclude false positives along a horizontal ladder, etc., for example, values are primarily sought here that comprise the standard dimensions of parking spaces. The aforementioned parameters are derived repeatedly for each frame of the driver observation camera 5. The saccades 2′ depicted in FIG. 2, for example, have a small angular deviation from the optical flow 6a, while at the same time the saccades 2′ have small angular deviations from each other. If the length of the saccades 2′ correlates with the corresponding parking space dimensions, it can be concluded without doubt that the user intends to park and is looking for a parking space. In contrast, the saccades 2 corresponding to the representation in FIG. 1 are disordered in relation to each other, deviate from the optical flow 6a and have different dimensions that do not correlate with the parking space dimensions, such that a parking intention on the part of the user can be ruled out.

For an evaluation, the final values of the parameters are determined by the computing unit 1 using a respective histogram from the consecutive frames, wherein the respective histogram indicates occurrence frequencies of individual values or value classes of the parameters determined in a history, in order to form parameter mean values as respective end values of the respective parameters from the respective histogram, for example by summing parameter values of a class or their mean value multiplied by respective frequencies and dividing them by the total number of parameter values. After determining a respective end value of a respective parameter, the computing unit 3 determines a weighted sum with weighting factors for each of the end values of these parameters “orientation”, “repeatability” and “connection” and compares the result of the weighted sum with a predetermined limit value. If the limit value lies within a predetermined range below a predetermined threshold value, i.e., if it falls below the threshold value, it is assumed that the driver intends to park, preferably if the saccades with this characteristic have been occurring for a certain minimum duration. In a modification, end values can be formed from the histograms in a simplified form for only one or two of the parameters and calculated using weighting factors.

However, this analysis of fixations and saccades to determine whether the driver of the vehicle intends to park is only performed for fixations that are directed at an environment of the vehicle 1 outside a flat road course 7 of a section of road lying in front of the vehicle 1 in the direction of travel, and only for saccades that at least partially, in particular completely, only cover areas of the environment of the vehicle 1 outside the flat road course 7. The flat road course describes a surface of at least one drivable road in the environment ahead of the vehicle 1. Side roads can also be comprised in the flat road course. The flat road course is therefore determined on the one hand by the elongated road course in a respective direction of travel, which includes straight sections, curves, etc., and on the other hand by the respective width at the respective location of the elongated road course, wherein the width is indicated in FIG. 1 by two dashed boundary lines of a two-lane road with a center marking.

The assignment of the directions of gaze of the fixations in the environment of the vehicle 1 or the areas of the environment of the vehicle 1 covered by the saccades based on the fixations and saccades in the driver's gaze behavior determined by the driver observation camera 5 is performed by the computing unit 1 by means of coordinate system transformations. For this purpose, a position and orientation of the vehicle 1 relative to the road are determined in the form of position angles by using satellite-based positioning to determine the current position of the vehicle 1 and the course of the road immediately ahead with its respective width is determined from information from a digital map, wherein the coordinate system transformations are based on the position angles, which represent the only transformation variable, since it can be assumed that the driver observation camera 5 is fixed in position relative to the rest of the vehicle 1. When the intention is recognized, the automatic parking assist is activated to such an extent that possible parking spaces are marked and displayed to the driver of the vehicle on a head-up display on the windscreen in front of their driver's seat using augmented reality, and thus the driver of the vehicle can initiate the automatic parking of the vehicle 1 in this selected parking space by selecting one of these offered parking spaces and issuing a command, for example a voice input or other operating action. Alternatively or additionally, the driver is offered a visualization of an activation option for an automatic parking function on an instrument cluster, a switch or a head unit.

Although the invention has been illustrated and explained in detail by preferred exemplary embodiments, the invention is not limited by the disclosed examples, and other variations can be derived from them by those skilled in the art without departing from the scope of protection of the invention. It is therefore clear that a plurality of variations are possible. It is also clear that the embodiments cited as examples are really only examples and should not be construed in any way as limiting the scope of protection, the possible applications or the configuration of the invention. Rather, the preceding description and the description of the figures enable the person skilled in the art to implement the exemplary embodiments in concrete terms, wherein the person skilled in the art, knowing the disclosed inventive concept, can make a variety of changes, for example with regard to the function or arrangement of individual elements mentioned in an exemplary embodiment, without departing from the scope of protection defined by the claims and their legal equivalents, such as further explanations in the description.

1-10. (canceled)

11. A system for controlling an automatic parking assist of a vehicle, the system comprising:
a computing unit; and
a driver observation camera connected to the computing unit and configured to detect gaze behavior of a driver of the vehicle,
wherein the computing unit is configured to
infer, based on certain patterns of fixations and saccades in the gaze behavior of the driver, an intention to park the vehicle in a parking space;
determine, based on the inferring of the intention to park, that the driver intends to park;
activate, responsive to the determination that the driver intends to park, the automatic parking assist at least in part, and
determine a flat road course of a section of road lying in front of the vehicle in a direction of travel of the vehicle, to
assign gaze directions of the driver to a current surroundings of the vehicle, and
exclude fixations with a gaze direction towards the flat road course or saccades with gaze directions over at least part of the flat road course from the inference, based on patterns in the gaze behavior of the driver, for the intention to park the vehicle in the parking space.

12. The system of claim 11, wherein the computing unit is configured to determine the flat road course of the road section in the direction of travel ahead of the vehicle by determining a current position of the vehicle and by assigning the determined current position to a digital map with stored road courses.

13. The system of claim 12, wherein the computing unit is configured to determine position angles of the vehicle relative to the flat road course of the road section based on the flat road course according to the digital map or by an inertial measuring unit of the vehicle.

14. The system of claim 11, further comprising:
an environment observation camera connected to the computing unit and configured to detect an area in front of the vehicle,
wherein the computing unit is configured to
determine a vector field of optical flow of the environment relative to the vehicle as the vehicle moves from current data from the environment observation camera, and
account for a reference of the gaze behavior to the vector field of the optical flow when inferring, based on patterns in the gaze behavior of the driver, the intention to park the vehicle in the parking space checking patterns in the gaze behavior for an intention to park.

15. The system of claim 14, wherein
the computing unit is configured to determine, by analyzing the saccades, values for at least one of a following parameters orientation, repeatability, and connection,
the parameter orientation indicates a respective orientation of the saccades relative to the direction vectors of the vector field of the optical flow,
the parameter repeatability characterizes a sequence of the saccades among themselves,
the parameter connection indicates a length of individual saccades, and
the computing unit is configured to infer an intention to park depending on respective determined values of the at least one parameter.

16. The system of claim 15, wherein the computing unit is configured to determine the respective value of the at least one parameter by a respective histogram, to form parameter mean values from the respective histogram as a final value of the respective parameter, wherein the respective histogram indicates occurrence frequencies of individual values of the at least one parameter.

17. The system of claim 16, wherein the computing unit is configured to
determine a weighted sum of the final values of the parameters orientation, repeatability, and connection, and
compare a result of the weighted sum with a predetermined limit value, and
conclude there is an intention to park responsive to the limit value not being reached.

18. The system of claim 17, wherein the computing unit is configured to adjust weighting factors of the weighted sum or the limit value based on learned field data.

19. The system of claim 18, wherein the computing unit is configured to perform the adjustment of the weighting factors differently for different individual drivers.

20. A vehicle comprising:
an automatic parking assist;
a computing unit coupled to the automatic parking assistant; and
a driver observation camera connected to the computing unit and configured to detect gaze behavior of a driver of the vehicle,
wherein the computing unit is configured to
infer, based on certain patterns of fixations and saccades in the gaze behavior of the driver, an intention to park the vehicle in a parking space;
determine, based on the inferring of the intention to park, that the driver intends to park;
activate, responsive to the determination that the driver intends to park, the automatic parking assist at least in part, and
determine a flat road course of a section of road lying in front of the vehicle in a direction of travel of the vehicle, to
assign gaze directions of the driver to a current surroundings of the vehicle, and
exclude fixations with a gaze direction towards the flat road course or saccades with gaze directions over at least part of the flat road course from the inference, based on patterns in the gaze behavior of the driver, for the intention to park the vehicle in the parking space.

21. A method for controlling an automatic parking assist of a vehicle, the method comprising:
detecting, by a driver observation camera of the vehicle, gaze behavior of a driver of the vehicle;
providing, by the driver observation camera to a computing unit of the vehicle, the detected gaze behavior of the driver of the vehicle;
inferring, by the computing unit based on certain patterns of fixations and saccades in the gaze behavior of the driver, an intention to park the vehicle in a parking space;
determining, by the computing unit and based on the inferring of the intention to park, that the driver intends to park;
activating, by the computing unit responsive to the determination that the driver intends to park, the automatic parking assist at least in part; and
determining a flat road course of a section of road lying in front of the vehicle in a direction of travel of the vehicle, to
assign gaze directions of the driver to a current surroundings of the vehicle, and
exclude fixations with a gaze direction towards the flat road course or saccades with gaze directions over at least part of the flat road course from the inference, based on patterns in the gaze behavior of the driver, for the intention to park the vehicle in the parking space.
